(19) United States
(12) Patent Application Publication
(10) Pub. No.: US 2013/0040275 A1
(43) Pub. Date: Feb. 14, 2013

(54) Method for Educational Instruction

(71) Applicant: Pavan R. Gowda, Fremont, CA (US)

(72) Inventor: Pavan R. Gowda, Fremont, CA (US)

(21) Appl. No.: 13/572,590

(22) Filed: Aug. 10, 2012

Related U.S. Application Data
(60) Provisional application No. 61/523,106, filed on Aug. 12, 2011.

(51) Int. Cl. G09B 5/00

(52) U.S. Cl. 434/322

(57) ABSTRACT

A method for education is provided. The method includes providing content about an educational subject and technology skills to a learner via a computer network with feedback and assistance available as the learner acquires knowledge.

### CROSS-REFERENCE TO RELATED APPLICATIONS

This application claims the benefit of U.S. Provisional Application No. 61/523,106, filed on Aug. 12, 2011, which is incorporated herein by reference in its entirety.

### FIELD OF THE INVENTION

The invention relates to a method and computer network for providing educational instruction to a learner.

### BACKGROUND

The current educational system through which educational material is disseminated to students has a number of serious drawbacks. For example, on top of an overall shortage of teachers, there is also a shortage of highly skilled teachers. Further, in many schools, advanced placement (AP) courses are not accessible or are accessible to only a subset of the student body. The efforts of students to learn material outside of the school curriculum is also poorly recognized.

Often, there is a lack of information provided to students to correlate what they are learning in the classroom with future college courses and potential career options. Counseling and guidance for career or advanced studies is often poorly provided or absent.

Tutoring or assistance by mentors is not available to all students who need help. Also, other than a small number of privileged students, the majority of students do not have access to the most current technologies and educational materials.

Frequently, educational subjects are taught in school in a way that does not capture students' attention and imagination, and the current educational system often does not encourage creativity. Opportunities for sharing of educational experiences between students are also minimal.

There is a need for new educational methods that address the above and other defects of the present educational system. The current educational system does not provide the opportunity for all students from diverse backgrounds, capabilities, accessibility needs, and geographic locations to gain the skills necessary for success in the workforce and global economy.

### BRIEF SUMMARY OF THE INVENTION

Educational methods and systems for implementation of the educational methods are provided.

In one aspect, a method is provided for educating a learner who desires to learn an educational subject. The method may include providing educational content to the learner via a computer network that contains user devices and a communication channel. At least a portion of the educational content may be stored in an electronic storage medium that is located remote from the user devices and delivered to a user device via a communication channel. The educational content may include (i) content about the educational subject, and (ii) content about technology skills. Access to the educational content may be provided to the learner on a user device, e.g., via a user interface, such that the learner acquires knowledge of the educational content by accessing said content. In some embodiments, the educational content is provided based on a customized learning roadmap created from the results of a pretest that measures the learner's skill level, and/or from the responses obtained via a questionnaire about the learner's interests and goals. Optionally, a communication channel may be available for providing feedback to the learner from an expert in the educational subject and/or a peer mentor who has more knowledge in the educational subject than the learner. Optionally, a communication channel may be provided to facilitate exchange of information and/or collaboration between learners who are learning the educational subject concurrently.

In another aspect, a method is provided for educating a learner who desires to learn an educational subject, comprising: (a) retrieving educational content from an electronic storage medium on a computer network that comprises a first user device and a first communication channel, wherein the electronic storage medium is remote from the first user device, wherein the educational content is stored in the electronic storage medium and delivered to the first user device via the first communication channel, and wherein the educational content comprises (i) content about the educational subject, and (ii) content about technology skills; (b) providing output from the electronic storage medium to the first user device, wherein the educational content is delivered to the first user device via the first communication channel, and wherein a learner acquires knowledge of the educational content by accessing said content on the first user device; and (c) providing input from the first user device to the electronic storage medium, wherein the learner provides feedback based on said acquired knowledge of the educational content, wherein said feedback is delivered to the electronic storage medium via the first communication channel. Optionally, the method includes providing a second communication channel between the electronic storage medium and a second user device, wherein educational content and/or feedback from the learner is retrieved from the electronic storage medium and delivered to the second user device via the second communication channel, wherein output from the electronic storage medium to the second user device is delivered to an expert in the educational subject and/or a peer mentor who has more knowledge in the educational subject than the learner and wherein the expert and/or peer mentor provides input to the electronic storage medium via the second communication channel, wherein said input provides feedback to the learner which is delivered from the electronic storage medium to the first user device via the first communication channel. Optionally, the method includes providing a third communication channel between the electronic storage medium and a third user device, wherein two learners who are learning the educational subject concurrently (e.g., a first learner and a second learner) may communicate with each other by sending input to the electronic storage medium via the first and third communication channels and accessing output from the electronic storage medium on the first and third user devices.

In another aspect, a method is provided for educating a learner who desires to learn an educational subject, comprising: (a) retrieving educational content from an electronic storage medium with a first user device on a computer network that comprises the first user device and a first communication channel, wherein the electronic storage medium is remote from the first user device, wherein the educational content is stored in the electronic storage medium and retrieved by the first user device via the first communication channel, and wherein the educational content comprises (i) content about the educational subject, and (ii) content about technology skills; (b) retrieving output from the electronic storage medium on the first user device, wherein the educational content is delivered to the first user device via the first communication channel, and wherein a learner acquires knowledge of the educational content by accessing said content on the first user device; and (c) providing input from the first user device to the electronic storage medium, wherein the learner provides feedback based on said acquired knowledge of the educational content, wherein said feedback is delivered from the first user device to the electronic storage medium via the first communication channel. Optionally, the method includes accessing educational content and/or feedback from the learner on a second user device, wherein said educational content and/or feedback is retrieved from the electronic storage medium by the second user device via a second communication channel, wherein output from the electronic storage medium to the second user device is accessed on the second user device by an expert in the educational subject and/or a peer mentor who has more knowledge in the educational subject than the learner and wherein the expert and/or peer mentor provides input to the second user device which is delivered to the electronic storage medium via the second communication channel, wherein said input provides feedback to the learner which is delivered to the first user device via the first communication channel. Optionally, the method includes providing a third user device, wherein two learners who are learning the educational subject concurrently (e.g., a first learner and a second learner) may communicate with each other by sending input to the electronic storage medium from the first and third user devices via the first and third communication channels and accessing output from the electronic storage medium on the first and third user devices.

In some embodiments, the educational content comprises content about more than one educational subject.

In some embodiments, the content about technology skills includes content about computer programming and/or computer game development skills and/or skills for preparation of a digital story. In some embodiments, the content about technology skills includes content about use of a user interface for accessing content from the computer network and/or communicating with experts, peer mentors, and/or other learners via the computer network.

In some embodiments, the method includes pre-testing the learner to determine the learner's preexisting knowledge of the educational subject and/or technology skills. The learner may begin access of educational content at the level that is appropriate based on the learner's preexisting knowledge.

In some embodiments, the method includes providing criteria for a report to demonstrate the learner's acquisition of knowledge of the educational content. The learner may prepare a report to satisfy the criteria. Optionally, the report may be in the form of a computer game or digital story report. Optionally, the report may be reviewed, for example by one or more experts in the educational subject and/or one or more experts in the technology skills used to generate the report. The learner may optionally receive an incentive based on review of the report. In some embodiments, such an incentive may include points that may be compared to points received by other learners who are learning the same educational content according to the method. In some embodiments, review of the report may include review and scoring of at least one (i.e., one, two or all three) of: (i) the learner's knowledge of the educational subject; (ii) technology skills; and (iii) professional skills. “Professional skills” may include teamwork, collaboration, and/or communication strategies with experts, peer mentors, and/or other learners. In one embodiment, the report is developed with a framework that includes a gestural interface. The report may include a computer game that is played or a digital story that is viewed using the gestural interface. Optionally, the gestural interface may by a wearable gestural interface.

In some embodiments, the method includes at least two levels, for example, a first level and a second level, with the second level containing educational content that is more advanced than the first level. In one embodiment, the method further includes a third level, with the third level containing educational content that is more advanced than the second level. Optionally, the learner may prepare a report after each level to demonstrate the learner's acquisition of knowledge of the educational content provided at each level. In some embodiments, a learner may access educational content in a more advanced level based on a satisfactory review of the report generated by the learner in a less advanced level.

In some embodiments, the method includes a post-test after the learner has completed the method or has completed one or more levels of a multi-level method. The post-test may assess at least one (i.e., one, two, or all three) of (i) the learner's knowledge of the educational subject; (ii) technology skills; and (iii) professional skills. Post testing may include a written examination, an oral examination, or an examination with both written and oral components.

In some embodiments, a cumulative point total is provided to the learner based on points earned from the report generated at the end of the method or at the end of all levels of a multi-level method, points earned by peer mentoring and/or collaborating with other learners, and/or the points earned in a post-test.

### BRIEF DESCRIPTION OF THE DRAWINGS

FIG. 1 depicts an example embodiment of an educational method as described herein.

FIG. 2 depicts an example embodiment of an educational method as described herein.

FIG. 3 depicts an example embodiment of a system for implementation of an educational method as described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

This disclosure is drawn, inter alia, to methods, systems, apparatus, computer programs, educational software, and networks related to delivery of educational content to a learner, and collaboration, communication, and/or mentoring between and among learners, experts, and/or mentors (e.g., peer mentors).

Interactive methods and systems for delivering educational content to a learner are provided. The methods and systems described herein include a computer network with user devices and an electronic storage medium whereby educational content is delivered to the learner on a user device via a communication channel between the storage medium, which contains at least a portion of the educational content, and the user device. The educational content to be delivered contains both content about one or more educational subject(s) and content about technology skills, such as computer programming, computer game development, and/or digital storytelling. Optionally, the learner may communicate with and receive feedback from one or more experts and/or peer mentors and/or other learners concerning the educational subject(s) and/or technology skills.

### Definitions

“A,” “an” and “the” include plural references unless the context clearly dictates otherwise.

“Computer network” refers to a collection of computers and/or devices interconnected by communication channels to facilitate communication and sharing of resources and information among interconnected devices. For example, a computer network may include two or more user devices linked together for the purposes of sharing information and/or resources.

“Electronic storage medium” refers to any media in which information may be stored digitally for future retrieval. Nonlimiting examples of electronic storage media include magnetic storage (e.g., disk drive), optical storage, electrical storage (e.g., semiconductor, floating gate transistor), disc storage (e.g., CD, DVD), flash memory/memory card (solid state semiconductor memory, e.g., USB flash drive or memory stick), and Zip drives. In certain embodiments, an electronic storage medium may be on a server or on multiple servers that work together to capture data from and to provide data to user device(s) in a method as described herein.

“Communication channel” refers to a path through which data is transmitted from one computer or device to another computer or device. Data may be transmitted through a physical channel (e.g., a wire) or wirelessly. In some embodiments, data may be transmitted over the Internet. In some embodiments, data may be transmitted through one or more servers.

“Social network” refers to a computer network configured to facilitate the exchange of information, comments, or other feedback or input between individuals, such as individuals at different locations exchanging content and/or comments through an Internet connection, wherein such content and/or comments may be posted and recorded for others in the social network to view and further comment upon if desired.

“Cloud network” refers to a computer network that permits access to a shared pool of computing resources, for example, networks, servers, storage, applications, etc. Software and data may be stored on a remote infrastructure and accessed by an end user, for example, through the Internet via a browser on a user device.

A “gestural interface” provides a link between a digital device and an individual's interactions with the physical world by tracking a user's hand or body gestures, physical objects, facial gestures, and/or spoken commands. Such an interface may include a projector and camera or similar sensing device. A nonlimiting example of a gestural interface is a “wearable gestural interface” such as, for example, a pendant, that includes a sensing device and may be worn by a user.

“Expert” refers to an individual who has advanced knowledge in an educational subject, such as, for example, a university professor, educator, or author who works, teaches, and/or has knowledge in the field of the educational subject or an individual who is employed in the field of the educational subject.

“Peer mentor” refers to an individual who is learning an educational subject according to the method described herein but who has reached a more advanced level of the method or is farther along in learning the subject in the same level of the method than a learner who is being mentored in the educational subject by the peer mentor.

“Digital story” refers to a digital animation based on subject knowledge obtained in an educational method as described herein, produced using a provided technical framework.

### Educational Methods

Methods are provided for educating a learner who desires to learn an educational subject. The methods described herein include providing educational content to the learner via a computer network that contains a user device, an electronic storage medium on which at least a portion of the educational content is stored, and a communication channel, e.g., for transmitting input and output between the electronic storage medium and the user device. Educational content is delivered from the electronic storage medium to the user device via the communication channel, and is accessed on the user device by the learner. The learner acquires and/or increases knowledge of the educational content by accessing the content on the user device. The learner may access educational content and/or communicate with other users of the computer network, for example, experts, peer mentors, and/or other learners, via a user interface on the user device. Educational content may be delivered from the electronic storage medium through a communication channel to the user device and accessed via the user interface.

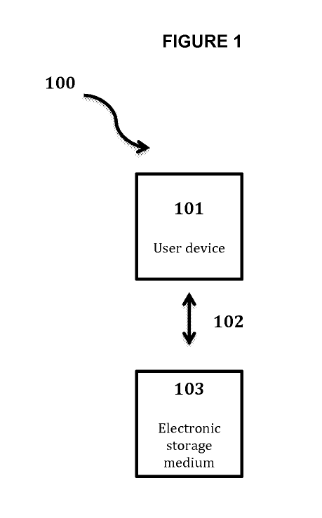

In one example embodiment, depicted in FIG. 1, in an educational method 100 as described herein, a learner may access educational content on a user device 101. Educational content may be stored on an electronic storage medium 103 and delivered to the user device via a communication channel 102 through which the user device may receive input from the electronic storage medium and through which the user device may transmit data to the electronic storage medium. In various embodiments, the electronic storage medium 103, which contains educational content, may be external to the user device 101, such as on an external computer network or server, or may be internal to the user device 101, such as on a hard drive or removable storage medium such as a CD, DVD, or USB drive.

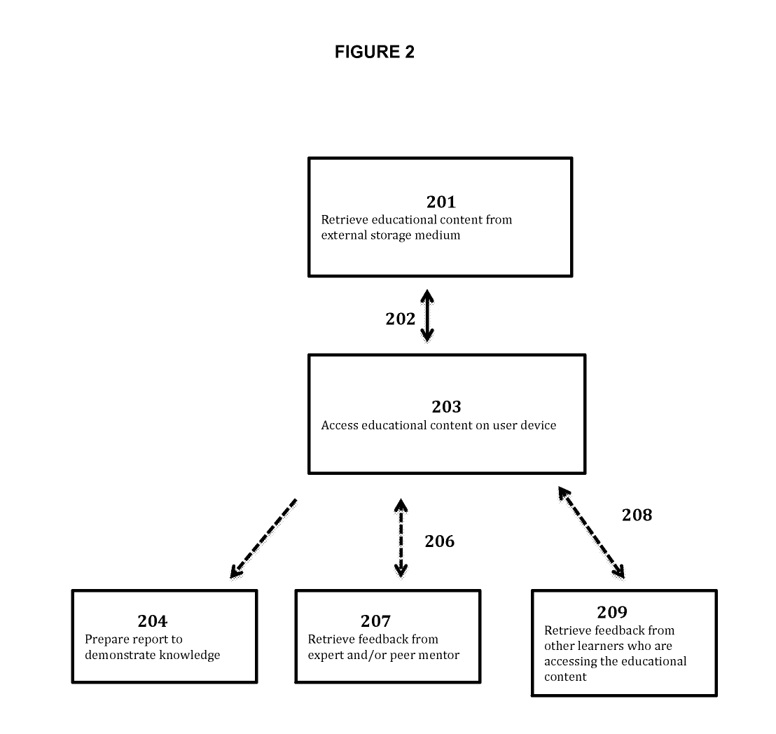

In one example embodiment of an educational method described herein, depicted in FIG. 2, educational content is retrieved from an external storage medium 201. The educational content may comprise, for example, (i) content about one or more educational subject(s) and (ii) content about technology skills. Educational content is delivered via communication channel 202 to a user device 203. Optionally, a report 204 is generated as output from the user device 203 to demonstrate acquisition of knowledge of the educational content. Optionally, feedback 207 is retrieved from an expert and/or peer mentor via a communicational channel 206 between the expert and/or peer mentor and the user device 203. Optionally, feedback 209 is retrieved from one or more other learner(s) who are accessing the educational content, via one or more communication channel(s) 208 between the other learner(s) and the user device 203.

The educational content includes content about one or more educational subject(s) that the learner desires to acquire knowledge about, and content about technology skills. The educational subject(s) may include, but are not limited to, mathematics, science, language, literature, art, history, social sciences, or humanities. Any educational subject that is taught in K-12, elementary school, secondary institutions (e.g., middle school, high school), or post-secondary institutions such as colleges or universities may be taught to a learner with this method.

The educational content also includes content about technical skills which may be used to generate a report to demonstrate the learner's acquisition of knowledge about the educational subject(s). The technical skills may include, but are not limited to, computer literacy, computer programming, computer game development, digital storytelling, and/or skills for report generation and/or presentation such as, for example, word processing, spreadsheet, and/or slide production and/or presentation skills.

A user device on which the learner accesses educational content may be any device which is capable of receiving content from an electronic storage medium. Examples of such user devices include, but are not limited to, computer terminals, desktop computers, laptop computers, tablets, smart phones, etc.

Optionally, the user device is configured for the user to communicate with one or more expert(s) in the field of the educational subject(s), one or more peer mentor(s), and/or one or more learner(s) who are learning the same or different educational subject(s). Communication between the learner and experts, peer mentors, and/or other learners may be, for example, via the Internet or via an intranet. In some embodiments, the educational network is configured as a social network to facilitate communication between learners, experts, and/or peer mentors.

At least a portion of the educational content that is accessed by a learner may be stored on an electronic storage medium that is remote from the user device. The educational content may be accessed, for example, via the Internet, or via an intranet. In some embodiments, the educational content is stored in a cloud network. The educational content may optionally be accessed by the learner via a World Wide Web browser. In other embodiments, the educational content may be stored on the user device, for example, on a hard drive or other type of electronic storage medium.

In some embodiments, the method is adapted for self-study by students. In some embodiments, the method is adapted for use by educators in combination or in conjunction with classroom instruction.

### Levels of Advancement

Some embodiments of the educational methods herein include multiple levels (i.e., two or more levels), with learners progressing from a less advanced to a more advanced level as their knowledge of the educational content increases. Reports may be generated by the learner after completing each level or a single report may be generated after all levels of the method have been completed.

In one embodiment, a pretest may be administered before the first level of the method to determine placement of a learner at an appropriate level based on the learner's pre-knowledge of the educational content. The pre-test may test the learner's knowledge of the educational subject, technical skills, or both. The pretest may include a questionnaire, survey, or other device for assessing a user's interests and/or educational goals, and/or may measure a user's technical and/or educational skill proficiency. A learner who receives a passing score on the pretest may skip the first educational level or a portion of the first educational level (educational subject knowledge or technical skills, pre-knowledge of which is deemed sufficient as a result of the pretesting) or may skip a further level or portion of a further level based on the results of the pretesting. If both educational subject knowledge and technical skills are deemed sufficient, the learner may start the method with the second or further level. In some embodiments, a pretest may be used to develop a learning program or “roadmap” for learning an educational subject and/or technical skills within the educational methods described herein. The learning program may be customized to the individual learner's skill level and interests, for the educational subject matter and/or technology skills, based on information obtained from the pretest.

In one embodiment, the method includes beginner, intermediate, and advanced levels. For example, the beginner level may teach foundational educational subject material and technology skills, such as how to use the user interface of the technology framework and/or some basic computer programming skills and/or skills necessary for production of a report such as a computer game or digital story to be produced after completion of the beginner level. After generation and scoring of a report or some other type of assessment, the learner may progress to the intermediate level if knowledge of the beginner level is sufficient. The intermediate level may teach more advanced educational subject material and more advanced technology skills than the beginner level. The technology skills taught in the intermediate level may include computer programming skills and/or other technology skills that are more advanced than those taught in the beginner level and/or skills necessary for production of a report such as a computer game or digital story to be produced after completion of the intermediate level. After generation and scoring of a report or some other type of assessment, the learner may progress to the advanced level if knowledge of the intermediate level is sufficient. The advanced level may teach more advanced educational subject matter and more advanced technology skills than the beginner level. The technology skills taught in the advanced level may include computer programming skills and/or other technology skills that are more advanced than those taught in the intermediate level and/or skills necessary for production of a report such as a computer game or digital story to be produced after completion of the advanced level. It will be understood that the methods described herein may include more or less levels than the three levels described in this paragraph, with increasing complexity of educational content taught at each succeeding level. For example, the method may include at least two or any of two, three, four, five, six, seven, or more levels with content of increasing complexity. If a learner has technical skills that are at least as advanced as those taught in any level of the method, the learner may opt to learn only educational subject matter and skip the technology skills portion of the educational content for that level.

In some embodiments, a learner may retake one or more levels of the educational method or the entire course. This may be done to increase knowledge of the educational subject or to try to pass a level that was not passed on the first attempt in order to advance to the next level.

### Report Generation

In some embodiments, a report is generated by the learner at the end of the learning process or at an intermediate point between beginning and end of the learning process to demonstrate the learner's acquisition of knowledge of the educational content. In some embodiments, the report may also be used to assess the learner's acquisition of technical skills. Criteria may be provided to the learner to demonstrate such knowledge and/or skills, and the report may be prepared by the learner to satisfy the criteria. The report may be reviewed by expert(s) and/or peer mentor(s) and/or other learner(s). An incentive may be provided to the learner based on this review, such as, for example, acquisition of points or icons and/or access to a more advanced level of the educational content In some embodiments, an incentive is also provided to peer mentors and/or other learners for reviewing the report and/or providing guidance to the learner during acquisition of knowledge of the educational content. For example, peer mentors and/or other learners may acquire points, icons, etc., for providing assistance to the learner.

In some embodiments, the report may be based on educational subject knowledge acquired from the educational content and may be generated using the technical skills acquired from the educational content.

In some embodiments, two or more learners who are learning the same or different educational subject(s) may collaborate to generate a report jointly.

The report may be in any form that demonstrates knowledge of the educational content and/or technical skills learned in the method described herein. Examples of reports include, but are not limited to, computer games and digital story reports.

Any technical framework that permits a learner to generate a report that may be accessed by others may be used. In some embodiments, the report is developed with a technical framework that includes a gestural interface. A nonlimiting example of a gestural interface is Kinect Sensor (developed by Microsoft). In one embodiment, the gestural interface is a wearable gestural interface. A nonlimiting example of a wearable gestural interface is SixthSense technology (see, e.g., www.pranaymistrycom/projects/sixthsense/). In some embodiments, the report may include a computer game that is played using a gestural interface or a digital story that is viewed using a gestural interface.

In some embodiments, games, digital stories, and other reports may be published. Such published reports may be made available to the public for download. In some embodiments, a fee may be charged for the download of the report. At least a portion of such a fee may be provided to the student who developed the report, thus providing a financial incentive to develop a unique and creative report that will become a popular downloadable application.

### Post-Test

In some embodiments, a test may be given after a level of the educational method has been completed and/or after several levels, for example, after beginner, intermediate, and advanced levels, of the course have been completed. The post-test may test overall knowledge acquired about the educational subject(s) and/or technical skills and/or acquisition of professional skills such as collaboration, teamwork, etc. gained by working with others, for example, experts, peer mentors, and/or learners, throughout the course of study and/or report generation.

A post-test may be written or oral, or may include both written and oral components. In some embodiments, assessment of educational subject knowledge, technical skills, and/or professional skills may include or may consist of interviews and/or gathering of feedback, for example, in oral and/or written form, from others who have interacted with the learner during the course of the educational method, including but not limited to, expert(s), peer mentor(s), and/or other learner(s).

### Final Score

In some embodiments, a final score may be provided to a learner who has completed a course of study according to a method as described herein. The final score may be a cumulative score that includes points and/or other incentives earned for report(s) generated as described herein, a post-test score, and/or points and/or other incentives awarded for peer mentoring other learners.

### Further Educational Opportunities

In some embodiments, learners are provided with a listing or other resource(s) advising them of further educational courses that may be of interest once they have completed or concurrently with an educational method as described herein.

### Job and Internship Opportunities

In some embodiments, learners are provided with a listing or other resource(s) advising them of employers and/or other organizations of interest in a particular educational subject area. The employers and/or other organizations may voluntarily agree to be listed, for example, by paying a fee for such a listing. Learners may search a list of such listed employers to apply for employment, internships, etc.

In some embodiments, the scores that learners achieve in an educational method as described herein may be provided to prospective employers and/or other organizations of interest in a relevant educational subject area for purposes of such employers and other organizations providing job offers, offers of internships, etc. to the learners.

### Alumni Feedback and Comments

In some embodiments, the method may include an alumni network in which alumni who have completed the method in a particular educational subject area may contribute and/or comment. New learners may review such feedback and comments prior to and/or during a course of study in the same or different educational subject area. Such a review may motivate, inspire, and/or help a prospective learner make a decision as to which educational subject(s) will be of the greatest interest to the learner to pursue in a method as described herein, and/or may provide helpful hints for advancing through a course of study in the method.

### Portfolio

In some embodiments, a learner may create a portfolio and/or have a portfolio created automatically by the system, which portfolio may be updated based on the learner's activities and/or contributions in the educational methods described herein.

### Educational Systems

Systems are provided for use in an educational method as described herein. Systems may include user devices, communication channels, educational content, a technology framework for report generation and/or viewing, and any other network components, hardware, software, etc. for implementation of a method for educating a learner as described above, and a user interface for receiving and providing content via a computer and/or social network.

In some embodiments, a system for implementation of an educational method includes a computer network that includes user devices, communication channels, and educational content, and an electronic storage medium. The electronic storage medium may be located remote from the user devices, and at least a portion of the educational content may be stored in the remote storage medium and delivered to a user device via a communication channel. The educational content may be accessed via a user interface on the user device. The educational content may include content about one or more educational subject(s) and content about technology skills, as described supra. The computer network may be configured as a social network such that learners who access the educational content may communicate and exchange feedback with other learners of the same or different educational subject, peer mentors, and/or experts in the same or different educational subject(s). The system may include a technology framework or interface for development of a report after the learner has acquired knowledge of the educational content and/or for viewing or accessing the report. In one embodiment, the technology framework includes a gestural interface.

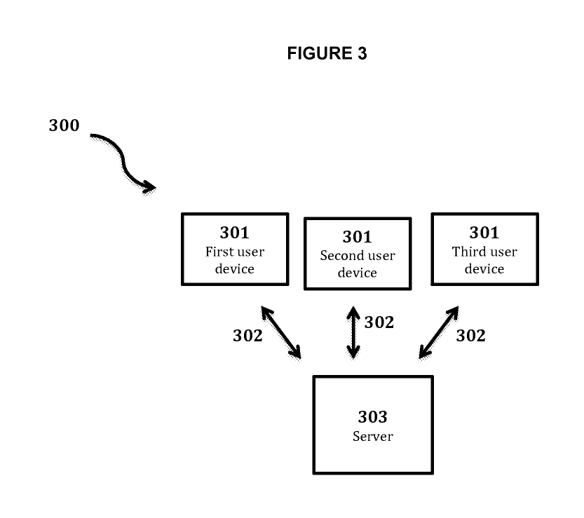

In one example embodiment, depicted in FIG. 3, a system 300 for implementation of an educational method as described herein contains user devices 301, which may access educational content through a device such as an external server 303 or other electronic storage device via communication channels 302. The user devices 301 may be used by learners, and optionally by expert(s) and peer mentor(s), for implementation of an educational method as described. Educational content and/or feedback between users, experts, and/or peer mentors may be delivered to the user devices 301 from the external storage device 303, and output from the user devices may be delivered back to the external storage device, via communication channels 302 between user devices and the external storage device.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention, which is delineated in the appended claims.

All publications, patents, and patent applications cited herein are hereby incorporated by reference in their entireties for all purposes and to the same extent as if each individual publication, patent, or patent application were specifically and individually indicated to be so incorporated by reference.

We claim:

1. A method for educating a learner who desires to learn an educational subject, comprising:
(a) providing educational content to the learner via a computer network that comprises a user device and a communication channel, wherein at least a portion of the educational content is stored in an electronic storage medium that is located remote from the user device and delivered to the user device via the communication channel, and wherein the educational content comprises (i) content about the educational subject, and (ii) content about technology skills;
(b) providing access to the educational content to the learner on the user device, wherein the learner acquires knowledge of the educational content by accessing said content;
(c) optionally providing a communication channel for providing feedback to the learner from an expert in the educational subject and/or a peer mentor who has more knowledge in the educational subject than the learner; and
(d) optionally providing a communication channel between the learner and other learners who are learning the educational subject concurrently.

2. A method according to claim 1, wherein the content about technology skills comprises content about computer programming and/or computer game development skills and/or skills for preparation of a digital story.

3. A method according to claim 1, further comprising:
(e) providing criteria for a report to demonstrate the learner's acquisition of knowledge of the educational content, wherein the learner prepares said report to satisfy said criteria, and wherein the report may optionally be in the form of a computer game or digital story report; and
(f) providing a review of the report whereby the learner receives an incentive based on said review.

4. A method according to claim 3, wherein the review is provided by one or more experts in the educational subject.

5. A method according to claim 3, wherein the method comprises at least two levels, wherein the at least two levels comprises a first level and a second level, wherein the second level comprises educational content that is more advanced than the first level, and wherein the learner prepares a report after each level to demonstrate the learner's acquisition of knowledge of the educational content provided at each level.

6. A method according to claim 5, further comprising a third level, wherein the third level comprises educational content that is more advanced than the second level.

7. A method according to claim 5, wherein the learner may access educational content in a more advanced level based on a satisfactory review of the report generated by the learner in a less advanced level.

8. A method according to claim 3, wherein the incentive comprises points that may be compared to points received by other learners who are learning the same educational content according to the method.

9. A method according to claim 3, wherein the report comprises a computer game or digital story developed by the learner.

10. A method according to claim 3, wherein the review of the report comprises review and scoring of at least one of: (i) the learner's knowledge of the educational subject; (ii) technology skills; and (iii) professional skills.

11. A method according to claim 10, wherein said professional skills comprise teamwork, collaboration, and/or communication strategies with experts, peer mentors, and/or other learners.

12. A method according to claim 10, wherein the review of the report comprises review and scoring of (i), (ii), and (iii).

13. A method according to claim 1, wherein the educational content comprises content about more than one educational subject.

14. A method according to claim 3, wherein the report is developed with a framework that comprises a gestural interface.

15. A method according to claim 14, wherein the report comprises a computer game that is played or a digital story that is viewed using the gestural interface.

16. A method according to claim 5, comprising post-testing the learner after completion of all levels of the method to assess at least one of: (i) the learner's knowledge of the educational subject; (ii) technology skills; and (iii) professional skills.

17. A method according to claim 16, wherein (i), (ii), and (iii) are assessed.

18. A method according to claim 16, comprising providing a cumulative point total to the learner based on points earned from the report generated at each level and the points earned in the post-test.

19. A method according to claim 16, wherein the post-testing comprises an oral examination.

20. A method according to claim 5, comprising pre-testing the learner to determine the learner's preexisting knowledge of the educational subject and/or technology skills, wherein the learner begins access of educational content at the level that is appropriate based on the learner's preexisting knowledge.

21. A method according to claim 1, comprising pretesting the learner to determine the learner's preexisting knowledge of the educational subject and/or technology skills, interests, and/or goals, developing an educational roadmap based on the results of the pre-test and tailored to the learner's skills, interests, and/or goals, and wherein the educational content provided to the learner is based on the educational roadmap.

22. A method according to claim 1, wherein the learner receives feedback from a peer mentor, wherein the peer mentor receives an incentive for providing said feedback, wherein the feedback comprises points that may be compared to points received by other peer mentors and/or learners.
